(19) United States
(12) Patent Application Publication
(10) Pub. No.: US 2024/0233446 A9
(43) Pub. Date: Jul. 11, 2024

(54) Mobile Ticketing Device for a Transport Vehicle of a Passenger Transport System

(71) Applicant: Scheidt & Bachmann GmbH, Mönchengladbach (DE)

(72) Inventor: Thomas Müller, Mönchengladbach (DE)

(21) Appl. No.: 18/484,818

(22) Filed: Oct. 11, 2023

(30) Foreign Application Priority Data
Oct. 20, 2022 (DE) 10 2022 127 735.6

(51) Int. Cl. G07B 15/00

(52) U.S. Cl. CPC G07B 15/00

(57) ABSTRACT

A mobile ticketing device for a transport vehicle of a passenger transport system, includes at least one ticketing module configured to perform a ticketing action, at least one acceleration sensor configured to measure an acceleration impacting the mobile ticketing device, wherein measuring the acceleration provides time-resolved acceleration values, at least one generator module configured to generate at least one measurement data set, containing at least one acceleration datum about at least one provided acceleration value, and at least one output module configured to output the at least one generated measurement data set.

### CROSS-REFERENCE TO RELATED APPLICATIONS

This application claims the benefit of German patent application No. 10 2022 127 735.6, filed Oct. 20, 2022, the disclosures of which are incorporated herein by reference in their entirety.

### TECHNICAL FIELD

The application relates to a mobile ticketing device for a transport vehicle of a passenger transport system comprising at least one ticketing module configured to perform a ticketing action. Furthermore, the application relates to a passenger transport system and a method.

### BACKGROUND ART

A present passenger transport system, in particular a public passenger transport system, serves to transport persons and users, respectively, by means of passenger transport vehicles (hereinafter referred to as transport vehicles). Exemplary and non-exhaustive transport vehicles of a passenger transport system are rail vehicles (e.g., suburban train, subway, streetcar etc.), motor vehicles (e.g., bus), but also water vehicles (e.g., ferry) and airplanes. A trip of a user with a transport vehicle from a trip start point to a trip end point is in particular referred to as a transport trip.

A ticket medium and ticket, respectively, is generally required for an authorized respectively permissible use of a transportation trip respectively a corresponding transportation service. The ticket medium can generally indicate that the user is authorized to perform the transport trip and to use the passenger transport system, respectively. In prior art passenger transport systems, for example, paper tickets can be used as ticket media, which must be purchased at a ticketing device prior to the start of the trip.

In addition to stationary ticketing devices that do not move during operation and are permanently arranged, for example, in a stop area such as a train station, etc., so-called mobile ticketing devices are known from the prior art.

A mobile ticketing device is in particular a ticket vending machine and/or a so-called farebox installed in a transport vehicle. In other words, a mobile ticketing device means in particular a ticket vending machine and/or farebox that is permanently installed in a transport vehicle. Mobile means in particular that the ticketing device, in contrast to a stationary ticketing device, may be moved by a transport vehicle in which it is in turn immovably fixed.

The advantage of mobile ticketing devices is that the installation of a plurality of stationary ticketing devices at a plurality of stops can be dispensed with. This can facilitate maintenance of the ticketing devices as this can (always) be carried out, for example, in a vehicle depot respectively vehicle yard. In addition, the risk of damage due to e.g., vandalism can be reduced with mobile ticketing devices.

A mobile ticketing device comprises at least one ticketing module for performing a ticketing transaction. For example, a mobile ticketing device may comprise: a printer (e.g., needle printer, thermal printer, or inkjet printer), in particular configured to print a ticket medium respectively a ticket, an electrically operated money handling equipment, in particular configured to accept coins and/or banknotes, and/or at least one user interface, e.g., in the form of a display and/or an input element.

In known mobile ticketing devices, (temporary) operational failures and/or damage at the mobile ticketing devices occur time and again. An operational failure regularly leads to a loss of revenue since a ticket sale is not possible during the failure of the mobile ticketing device. If an operational failure of a mobile ticketing device is detected by a service technician or another person, a search for a reason of the failure is carried out by a service technician. This involves a great deal of effort. In addition, it is suspected that a plurality of temporary operational failures of mobile ticketing devices go unnoticed and thus, in particular, are not remedied.

Therefore, it is desirable to create a possibility that enables a reduction of (temporary) operational failures and/or damages of mobile ticketing devices and, in particular, a detection of failed mobile ticketing devices in a timely manner.

### SUMMARY OF THE INVENTION

According to a first aspect of the application, a mobile ticketing device for a transport vehicle of a passenger transport system comprises at least one ticketing module. The ticketing module is configured to perform a ticketing action. The mobile ticketing device further comprises at least one acceleration sensor. The at least one acceleration sensor is configured to measure an acceleration impacting the mobile ticketing device. The measuring of the acceleration comprises providing (time-dependent acceleration values respectively) time-resolved acceleration values. The mobile ticketing device comprises at least one generator module. The generator module is configured to generate at least one measurement data set containing at least one acceleration datum about at least one provided acceleration value. The mobile ticketing device comprises at least one output module. The output module is configured to output the at least one generated measurement data set.

In that, in contrast to the prior art, according to the application, the mobile ticketing device is provided with at least one acceleration sensor for (at least almost continuously) measuring of an acceleration impacting the mobile ticketing device and subsequent (preferably automated) outputting of a measurement data set with at least one item of information about the measured acceleration, a possibility is provided which enables a reduction in the (temporary) operational failures of mobile ticketing devices and, in particular, a detection of failed mobile ticketing devices in a timely manner. The effort involved in detecting and repairing a failed and/or (potentially) damaged mobile ticketing device is reduced.

In particular, it has been recognized that a main reason for a damage and, in particular, of a temporary operational failure is not, or at least not only, the mobile ticketing device, but is regularly caused by vibrations, shocks, impacts and/or the like, which are transmitted from the transport vehicle to the mobile ticketing device, in particular during operation, and which, in particular, may lie outside the specification range of the mobile ticketing device, i.e., vibrations or shocks during operation may be greater than and/or last longer than the mechanical design limit of the mobile terminal device.

Mobile ticketing devices may be fastened in rail vehicles, such as commuter trains, subways, and/or streetcars, for example, on a grip bar or between two grip bars. For this purpose, a mobile ticketing device may have at least one (mechanical) fastening means. Preferably, the fastening means, which may be arranged between a housing of the mobile ticketing device and the at least one grip bar, may have at least one vibration-damping component, such as an elastomer-based spring element and damper element, respectively. In addition, in the case of rail vehicles, the driving conditions of rail vehicles are also rather moderately stressful with respect to unevenness of the track. The same applies to the rather smooth running of the drive chain of a rail vehicle.

Nevertheless, according to the application, it has been found that sometimes a vibration-based (temporary) failure of a mobile ticketing device and/or damage also occurs in mobile ticketing devices of rail vehicles.

In road vehicles, such as a bus of a (public) passenger transport system, the mechanical installation conditions of a mobile ticketing device are usually more difficult than in rail vehicles. On the one hand, the (mechanical) fastening means of a mobile ticketing device may not comprise a vibration damping component or may only comprise a vibration damping component to a lesser extent. Vibrations and oscillations, respectively, of the transport vehicle are therefore usually transmitted to the mobile ticketing device in a less damped manner.

On the other hand, the driving conditions of the road vehicle itself may be much more robust than those of rail vehicles. For example, a bus has been found to transmit a high vibration load to an installed mobile ticketing device, in particular due to inherent vibrations from the drive chain as well as driving on roads with large uneven surfaces (e.g., potholes, cobblestones, etc.).

In addition, the installation conditions and the mounting structure, respectively, may vary, e.g., depending on vehicle type, vehicle age, wear and tear during operation, deviations from the installation specification. For example, the ticketing device may be fastened not only to or between grip bars, but additionally or alternatively directly to the vehicle structure and/or other interior components, for example to a dashboard or on the vehicle floor.

In particular, it has been recognized that exceeding the mechanical design limits may be caused by the operating conditions of an individual mobile ticketing device, such as repeated driving on routes with (extremely) poor road conditions, or repeated driving in the resonance range of the installed mobile ticketing device (this means that the vibration excitation itself does not exceed a critical value, but the installed mobile ticketing device resonates, so that the mobile ticketing device in particular experiences an excessive vibration load).

On the other hand, actual loads may be greater than the mechanical design limits caused by installation errors of an individual mobile ticketing device. For example, a fastening means between the ticketing device and the vehicle (screws and the like) may not have been properly fixed or may have come loose again. Such errors can lead to the mechanical design limits of an installed ticketing device being exceeded. The consequences are an increased wear and a reduction in availability.

Mobile ticketing devices in the form of fareboxes can be particularly affected by this. A farebox can also be referred to as an electronic payment table.

In particular, a farebox is a mobile ticketing device that is used in a transport vehicle, in particular a bus, in the United States of America. The mechanical installation situation of fareboxes is practically standardized in that a farebox respectively the housing of the farebox with a predominantly square ground plan of about 26×26 cm (10×10 inches) and a height of about 100 cm is attached, in particular screwed, to the floor of a transport vehicle within reach of the driver.

The mechanical connection between the floor of the transport vehicle and the farebox and the fastening means of the farebox, respectively, generally does not have a vibration damping component. According to the application, it has been found that, in particular in the case of a farebox, vibration-related (temporary) operational failures of the farebox and/or damages occur, at least of the at least one ticketing module of the farebox repeatedly. By means of a mobile ticketing device according to the application, in particular a farebox according to the application, a failure and/or a (potential) damage can be detected, and in particular corresponding counter measures can be taken.

By the fact that, according to the application, a monitoring arrangement, comprising at least the acceleration sensor, the generator module and the output module, is integrated in the mobile ticketing device for monitoring the acceleration impacting the mobile ticketing device during operation, operational failures and/or damage due to an (impermissible) acceleration as a result of an impermissible vibration can be detected (in a timely manner). Measures can then be taken (in a timely manner) to remedy the reason of the failure.

The mobile ticketing device according to the application serves for use in a passenger transport system. A passenger transport system according to the application is in particular a public passenger transport system and serves to transport passengers respectively users by means of passenger transport vehicles (hereinafter referred to as transport vehicles). Exemplary and non-exhaustive transport vehicles are rail vehicles (e.g., train, subway, streetcar, etc.), motor vehicles respectively road vehicles (e.g., bus), but also water vehicles (e.g., ferry) and airplanes.

As has already been described, a mobile ticketing device is to be understood in particular as a device for dispensing and/or validating ticket media wherein said device is permanently installed respectively mounted in a transport vehicle. A ticket medium that can be dispensed is in particular a paper-based ticket. Exemplary further ticket media that can be validated in particular by a mobile ticketing device are tokens, chip cards (respectively smart cards), credit cards, bank cards (or the like), cell phones, personal digital assistants (PDAs), tablet PCs, integrated circuit chips, electronic passports, electronic ID documents, etc.

In particular, a mobile ticketing device according to the application means a ticketing device with an average power consumption of at least 40 watts and/or with a peak power consumption of at least 80 watts. Mobile ticketing devices with a lower power consumption, such as validating devices and validators, respectively, are in particular not mobile ticketing devices according to the present application.

Preferably, the mobile ticketing device is a ticket vending machine and/or a farebox, which in particular is permanently installed in a transport vehicle of the passenger transport system in an intended operation. A farebox may also be referred to as an electronic pay table.

A mobile ticketing device may comprise at least one (e.g., electrically operated) ticketing module. A ticketing module is configured to execute respectively perform a ticketing action.

Preferably, the mobile ticketing device may comprise a printer (e.g., needle printer, thermal printer, or inkjet printer) as a ticketing module. A printer may be configured to perform a ticketing action in the form of printing a ticket medium and a ticket, respectively.

Alternatively or additionally, the mobile ticketing device may comprise as a ticketing module a money handling equipment (e.g., at least partially electrically operated) configured at least to accept cash, optionally also to additionally dispense change. A money handling equipment may be configured to perform a ticketing action in the form of accepting/dispensing coins and/or banknotes. For example, a money handling equipment may comprise an electric motor as a drive for a banknote feeder. In addition, the mobile ticketing device may comprise a money storage device (also referred to as a “cashbox”) in which the accepted money is stored. This may exclude money stored in an exchange device.

Alternatively or additionally, at least one user interface may be provided as a ticketing module, e.g., in the form of at least one (optical) display (e.g., a touch display, etc.) and/or at least one input element. A ticketing action may be a displaying and/or a detecting of an input.

A further ticketing module that may be integrated in a mobile ticketing device may be a contact-based and/or wireless-based interface configured to perform a ticketing action in the form of reading a storage means of a ticket medium. Non-exhaustive examples of a contact-based interface comprise magnetic stripes and Europay Mastercard VISA chips (EMV chips); examples of preferred contactless-based interfaces include Nearfield Communication interfaces (NFC interfaces) as defined in ISO 14443.

In addition, a ticketing module may be a data storage configured to perform a ticketing action in the form of storing at least one sales data set.

A still further ticketing module may be at least one further wired-based and/or wireless-based interface configured to perform a ticketing action in the form of transferring the stored sales data sets. A preferred further interface may in particular be a WLAN (Wireless Local Area Network) interface.

According to one embodiment of the mobile ticketing device according to the application, the mobile ticketing device can comprise at least one electrical connector equipment, which can be configured to electrically connect the on-board power supply of the transport vehicle and at least one electrically operated ticketing module of the mobile ticketing device. An internal power network may be implemented between the electrical connector equipment and the at least one electrically operated ticketing module.

The electrical connector equipment is in particular a power supply unit. In particular, the power supply unit serves to convert an electrical parameter provided by the on-board power supply with a certain value into a value required for the at least one electrically operated component of the mobile ticketing device. In particular, an input voltage provided by the on-board power supply with a certain voltage value can be converted into a voltage value required for the at least one electrically operated component of the mobile ticketing device. In particular, the power supply unit may be a so-called DC/DC power supply unit that converts an input voltage provided as a DC voltage into a DC voltage value that is required for the at least one electrically operated component of the mobile ticketing device.

In addition to an electrical connector equipment, the mobile ticketing device may also comprise at least one mechanical connector equipment respectively at least one mechanical fastening means configured to mechanically couple the mobile ticketing device to the transport vehicle. In other words, the mechanical fastening means serves for fixedly respectively permanently mechanically fastening the mobile ticketing device to respectively in the transport vehicle.

According to the application, the mobile ticketing device comprises at least one acceleration sensor. The acceleration sensor measures the acceleration impacting the mobile ticketing device, in particular substantially continuously. In other words, vibrations and oscillations, respectively, experienced by the mobile ticketing device during operation can be detected by the at least one acceleration sensor.

Preferably, the mobile ticketing device may comprise a housing having at least one housing wall. The at least one ticketing module may be arranged in respectively at the housing.

Preferably, the at least one acceleration sensor may be attached to the housing, in particular to a housing wall (preferably to an inner side of a housing wall). In one embodiment, the at least one acceleration sensor may be arranged in a head section of the mobile ticketing device. An impact and/or a vibration may be transmitted to the mobile ticketing device, in particular to the at least one housing wall, via the at least one mechanical fastening means and/or a further contact area between the transport vehicle and the mobile ticketing device, and then measured by the acceleration sensor.

Vibrations are understood to mean, in particular, periodic, medium-frequency to higher-frequency and low-amplitude mechanical vibrations. Mechanical shock means, in particular, a single strong acceleration.

The measuring of the acceleration by the acceleration sensor comprises providing time-dependent acceleration values respectively time-resolved acceleration values by the acceleration sensor. In particular, the acceleration sensor may be configured to measure at least one voltage signal and to convert respectively translate the at least one voltage signal into time-resolved acceleration values. In particular, digital time-resolved acceleration values can be provided by sampling the (analog) voltage signal. The sampling frequency and sampling rate, respectively, may be between 50 Hz and 200 Hz, preferably 100 Hz. Furthermore, the acceleration sensor may be configured to measure accelerations of at least ±4 g.

Preferably, the acceleration sensor can store the individual measured values with associated time values in a data memory of the mobile ticketing device. In particular, an acceleration sensor measures its own acceleration. For example, a piezoelectric accelerometer or a MEMS (Micro-Electro-Mechanical System) accelerometer may be provided.

Furthermore, preferably the acceleration sensor may be a 3-axis acceleration sensor, in particular configured to measure three corresponding voltage signals (one for each axis) depending on the respective acceleration and position of the 3-axis acceleration sensor. The 3-axis accelerometer may be configured to convert respectively translate the three voltage signals into corresponding axis-related and time-resolved acceleration values.

Furthermore, the mobile ticketing device comprises a generator module configured to generate at least one measurement data set containing at least one acceleration datum about the measured acceleration. Preferably, the measurement data set may be an acceleration measurement data set containing at least one provided acceleration value and/or one acceleration datum based thereon.

In one case, the acceleration datum may be the measured acceleration respectively acceleration values thereof.

The mobile ticketing device further comprises an output module configured to output the generated measurement data set. According to one embodiment, the output module may comprise and form, respectively, a communication unit (e.g., the described further contact-based or contactless-based interface). In particular, the communication unit may be configured to transmit the at least one measurement data set via a (wireless and/or wired) communication network to a further system respectively device, such as a background system of the passenger transport system and/or a mobile terminal (for example of a service technician) of the passenger transport system.

According to a further embodiment of the mobile ticketing device according to the application, the mobile ticketing device may comprise at least one evaluation equipment. The evaluation equipment may be configured to evaluate the acceleration values (provided by the acceleration sensor).

The evaluation equipment may comprise at least one high-pass filter configured to high-pass filter the provided acceleration values. The provided acceleration values respectively the provided sensor data can be high-pass filtered in order to remove, in particular, constantly-impacting accelerations, such as the acceleration due to gravity, from the provided sensor data. This can improve a subsequent further evaluation of the acceleration values.

As has already been described, the mobile ticketing device can comprise at least one evaluation equipment configured to evaluate the provided acceleration values. According to a preferred embodiment of the mobile ticketing device according to the application, the evaluation equipment may comprise at least one vibration loading module. The vibration loading module may be configured for determine a (mean) oscillation energy as a (mean) vibration load based on the provided acceleration values, in particular the provided time-resolved and high-pass filtered acceleration values. The acceleration datum can preferably be the determined (mean) oscillation energy. The oscillation energy, in particular the mean oscillation energy, is particularly suitable as a variable for an evaluation of a vibration situation. In particular, the evaluation of the mean oscillation energy allows to determine whether an experienced acceleration is inadmissible for the ticketing device, i.e., potentially damaging, or not.

A vibration situation means a situation in which an acceleration is measured by the acceleration sensor due to vibrations that have occurred and/or at least one impact that has occurred.

In principle, the (mean) oscillation energy can be determined by the vibration loading module in any way. According to a preferred embodiment of the mobile ticketing device, the vibration loading module may comprise an absolute value computing element. The absolute value computing element may be configured to determine respective acceleration absolute values for the respective provided acceleration values, in particular the provided time-resolved and high-pass filtered acceleration values. In particular, it has been recognized that any acceleration is structurally stressful to the mobile ticketing device independent of the coordinate direction. An acceleration in the negative coordinate direction can be just as structurally stressful to the ticketing device as an acceleration in the positive coordinate direction. By forming acceleration absolute values, acceleration values can be evaluated independently of the coordinate direction.

Preferably, the vibration loading module may comprise an integration computing element. The integration computing element may be configured to determine a hypothetical velocity by calculating a time integral over the determined acceleration absolute values during a specific evaluation time period.

Preferably, the time integral over the acceleration can be formed by the integration computing element over a specific evaluation time period T. In particular, the time integral indicates a hypothetical velocity that the acceleration sensor would assume if all measured accelerations over the evaluation time period T acted on the acceleration sensor with the same sign.

Further, the vibration loading module may comprise an energy computing element configured to determine an equivalent for the (mean) oscillation energy by squaring the calculated time integral. Since the kinetic energy is proportional to the square of the velocity, the determined time integral can be squared. In particular, the resulting value provides an equivalent for the mean oscillation energy respectively vibration energy impacting the acceleration sensor during the evaluation time period T. The equivalent for the mean oscillation energy can be assumed to be representative for the mean vibration load of the mobile ticketing device impacting the acceleration sensor and the mobile ticketing device, respectively, during the evaluation time period T.

It should be noted that the term “oscillation energy” used in the following does not have the physical unit of an energy (mass×velocity²), but only the square of the velocity is used as an equivalent for the oscillation energy; thus, in the equivalent for the oscillation energy, only the vibration velocity is considered and not the vibrating mass. For simplicity, this equivalent for the oscillation energy will be referred to as “oscillation energy” in the following.

According to one embodiment, the evaluation time period T can be between 1 to 10 seconds, preferably between 2 to 5 seconds.

The evaluation time duration T may be quasi-continuous rolling or formed from discrete time intervals of period T. Preferably, the evaluation time period T can be formed in a quasi-continuous rolling manner.

According to a particularly preferred embodiment of the mobile ticketing device according to the application, the evaluation equipment may comprise at least one comparator module. The comparator module may be configured to compare the provided acceleration values with a specific acceleration limit value. In particular, the comparator module may be configured to compare the determined average oscillation energy with a specific mean oscillation energy limit value.

The generator module may be configured to generate the at least one measurement data set only if at least one absolute value of the provided acceleration values is greater than the determined acceleration limit value. The generator module can in particular be configured to generate the at least one measurement data set only if the determined average oscillation energy is greater than the determined average oscillation energy limit value.

The specific, in particular adjustable limit value is preferably a threshold value. The at least one threshold value can in particular be selected and set in such a way that accelerations below the threshold value have no effect on the operability of the mobile ticketing device. This can be used to ensure that a measurement data set is only generated if there is a (potential) effect of an acceleration on the operability of the mobile ticketing device. The generated data volume can be significantly reduced by this.

In particular, the mean oscillation energy can be compared, by the comparator module, with the oscillation energy limit value, in particular an oscillation energy threshold value. In particular, only if the mean oscillation energy exceeds the oscillation energy limit value the occurrence of a problem can be assumed. Only if such a vibration situation is detected a measurement data set can now be generated by the generator module, and in particular measurement data can be recorded in the form of process data and event data, respectively. Measurement data in the form of process data and event data, respectively, can serve to identify the event respectively, the vibration situation and for downstream evaluations and can be transmitted to a background system, in particular in the form of the said measurement data set.

The transmitting of the at least one measurement data set can preferably take place in (quasi-) real time. In variants of the application, the at least one generated measurement data set may be temporarily stored and transmitted to the background system at a later time.

According to a further embodiment of the mobile ticketing device according to the application, the comparator module may be configured to suspend the comparing for a certain dead time if at least one absolute value of the provided acceleration values is greater than the specific acceleration limit value. In particular, the comparator module may be configured to suspend the comparing for a certain dead time if the determined mean oscillation energy is greater. This can further reduce the amount of data generated without negatively affecting the evaluation.

Preferably, it can be provided that after the generating of a measurement data set the comparing of the (preferably continuously) determined mean oscillation energy with the oscillation energy limit value can be suspended for the period of a certain and, in particular, adjustable dead time Td ea d. This can prevent a plurality of similar measurement data sets from being generated (in a short time) if a vibration load and shock load, respectively, continues.

The dead time T_{dead} can preferably comprise 1 to 5 evaluation times T. In other words: Once a measurement data set has been generated and recorded, respectively, the next measurement data set can be generated at the earliest after the dead time T_{dead}.

As has been described, a measurement data set may comprise at least one measurement datum, preferably a plurality of measurement data. According to a preferred embodiment of the mobile ticketing device according to the application, the at least one generated measurement data set may comprise at least one measurement datum selected from the group comprising:
ticketing device identifier,
time stamp (with calendar datum and preferably at least exact time to the second),
driver identifier (of the current driver of the transport vehicle),
fill level of the (coin) money storage of the mobile ticketing device,
route number and/or line number (of the current trip of the transport vehicle),
location data (e.g., last and/or next stop and/or GPS data),
at least one environmental datum of the mobile ticketing device (such as the current ambient temperature of the mobile ticketing device),
at least one vehicle status of the transport vehicle (such as door status (open or closed), vehicle speed, and/or engine speed).

The generated measurement data set may contain (in particular in addition to the acceleration datum) the time stamp as generation time datum (in particular a time stamp with calendar datum and preferably at least exact time to the second) of the measurement data set and a ticketing device identifier. Such a measurement data set can subsequently be evaluated in a simple manner. In particular, the ticketing device identifier enables a (one-to-one) identification of the mobile ticketing device in which the measurement data set was generated.

By recording the driver identifier, it can be determined, for example, in an evaluation described below, whether detected vibration situations correlate in particular with a specific driver. By detecting the fill level of the (coin) money storage of the money handling equipment of the mobile ticketing device, it can be investigated whether the fill level has an effect on vibration situations. By recording the route number and/or line number (of the instantaneous trip), it can be evaluated whether a specific route is particularly affected by vibration situations. This evaluation can be further improved if location data (e.g., GPS data) is detected and recorded.

In addition, at least one environmental datum of the mobile ticketing device (such as the current ambient temperature of the mobile ticketing device) may be recorded. In particular, the ambient temperature may have an impact on the vibration situation. Finally, the vibration situation may also depend on a vehicle datum, such as the door status (open or closed), the vehicle speed and/or the engine speed so that advantageously at least one vehicle datum may also be recorded by the generator module.

Said measurement data originates, for example, in part from the shift data of the mobile ticketing device itself and/or in part from an onboard data system of the transport vehicle, such as an IBIS system (Europe) or an SAE J1708 system (USA), to which the mobile ticketing device may have a data interface.

According to a particularly preferred embodiment of the mobile ticketing device according to the application, the mobile ticketing device may comprise at least one ring memory module configured to store the provided (in particular high-pass filtered) acceleration values with a certain holding period. The holding period may be between 0.2 minutes and 5 minutes, preferably around 1 minute. In the case of the ring memory module with a fixed memory size, said acceleration values can be stored continuously. When the ring memory module is full, the oldest acceleration values can be overwritten. This results in the acceleration values being available only for said limited holding period.

According to a further embodiment of the mobile ticketing device according to the application, the evaluation equipment may comprise at least one vibration loading module configured to determine a (mean) oscillation energy as a (mean) vibration load based on the acceleration values (instantaneously) stored in the ring memory module and, in particular, the acceleration values provided for an adjustable stopping time. Determining the (mean) oscillation energy can be performed, for example, as described previously.

The stopping time T_{after} can be at most the time capacity of the ring memory minus the evaluation time period T. This can increase the explanatory power of the oscillation energy in a measurement data set, in particular by not only transmitting the energy values (just) exceeding the mentioned limit value (which may all be in the same order of magnitude), but also by comprising a running-down oscillation energy value over the time T_{after}, which allows conclusions to be drawn about the vibration progression (decaying, persistent, increasing).

As already described, the acceleration datum can be the (mean) oscillation energy.

According to a further preferred embodiment of the mobile ticketing device, the generator module may be configured to generate the at least one measurement data set additionally containing the acceleration values stored in the ring memory module as a vibration pattern. In particular, a vibration pattern can be used to analyze the vibration situation even more precisely. For example, it can be determined from the vibration pattern which type of loading has occurred, i.e., whether, for example, a (single) impact or vibrations is/are the reason of the vibration pattern.

Since the recording of a vibration pattern by the generator module and the transmitting of a measurement data set with vibration pattern by the output module is data-intensive, it can be provided in particular that this function can be individually activated and deactivated (in particular by the background system) for each individual mobile ticketing device. This makes it possible for individual or specific mobile ticketing devices that have been found to be conspicuous or problematic in terms of their vibration load on the basis of a previous evaluation (still described below) to have detailed data on the vibration load retrieved as required, while this can be dispensed with for the other (presumably the vast majority) of the mobile ticketing devices that are inconspicuous in operation.

A further aspect of the application is a passenger transport system (described above). The passenger transport system comprises at least one mobile ticketing device installed in a transport vehicle as previously described. The passenger transport system comprises at least one background system comprising at least one communication module. The output module of the mobile ticketing device is configured to transmit the at least one measurement data set to the communication module.

The background system (also referred to as backend system) may be formed by at least one computing device, for example in the form of a server. For example, a plurality of distributed computing devices may be provided. Also, a cloud system may be implemented as the background system.

The passenger transport system may comprise the at least one transport vehicle, preferably a plurality of transport vehicles. In variants of the application, the passenger transport system may comprise at least one mobile terminal, in particular of a service technician. The mobile terminal may in particular comprise a service application, which may be configured according to the background system.

According to a preferred embodiment of the passenger transport system according to the application, the background system may comprise at least one evaluation module configured to evaluate the at least one transmitted measurement data set. In particular, the at least one evaluation module may be configured to recognize respectively detect a mobile ticketing device from a plurality of mobile ticketing devices with a vibration load that is outside a predetermined permissible load range based on a plurality of received measurement data sets. The evaluation module may be configured to determine individuals of the mobile ticketing devices for which a frequency of generated measurement data sets is detected. This frequency may be determined by comparing the number of all transmitted measurement data sets of all mobile ticketing devices within an evaluation time period. This allows, for example, the specific individuals to be considered separately in a reliability evaluation of the transport vehicles (fleet of devices) of the passenger transport system and/or to derive targeted service actions on the vehicles or specific mobile ticketing devices where the frequency occurs. This evaluation can be applied in particular if the mobile ticketing device has a described comparator module.

Preferably, the transmitted (and stored in the background system) historical measurement data sets of preferably a plurality of mobile ticketing devices can be evaluated regularly and/or at specific time points. In particular, the evaluation module can be configured to detect correlations, for example between vibrations that have occurred and certain types of transport vehicles and/or of vibrations and certain drivers and/or of vibrations and certain routes respectively route sections and/or of vibrations and certain vehicle states or states of a ticketing module. Preferably, the evaluation module can be configured to evaluate a plurality of transmitted measurement data sets, wherein evaluating the plurality of transmitted measurement data sets comprises determining at least one first measurement datum of a first measurement data set that has at least one correlation to at least one further measurement datum of a further measurement data set.

Preferably, an evaluation in the background system may be focused on detecting statistically significant correlations, such as, e.g. the question of whether certain drivers generate more measurement data sets (i.e., critical vibration loads) than the average of all drivers, whether frequencies of vibration loads can be detected on certain routes respectively in certain route sections, whether frequencies of vibration loads occur with individual ticketing devices, whether vibration loads occur more frequently with certain engine speeds of certain vehicles (e.g., determined by manufacturer, type designation, year of manufacture), etc.

If ring memory module data with recorded vibration patterns are available for a mobile ticketing device, then this detailed data can be displayed and evaluated for abnormalities, as has already been described.

According to a preferred embodiment of the passenger transport system according to the application, the background system may comprise at least one operating parameter change module. The operating parameter change module may be configured to generate an operating parameter data set based on the evaluation result of the evaluation module.

The communication module may be configured to transmit the generated operating parameter data set to at least the one detected mobile ticketing device and/or a further vehicle device of the transport vehicle of the corresponding mobile ticketing device. For example, a setting on a ticketing module may be changed to at least reduce the risk of temporary failure of a ticketing module. For example, the printing speed of a printer may be adjusted and/or the maximum permissible fill level of the (coin) money storage of the mobile ticketing device may be adjusted.

It may also be provided that a vehicle parameter, such as the maximum permitted vehicle speed, is adjusted, for example on a certain section of the route. For example, if it is determined in the evaluation that inadmissible vibration situations occur on a certain route section, the maximum permitted vehicle speed can be reduced for this route section. Also, the maximum permitted engine speed can be adjusted if it is determined in the evaluation that it has an influence on the occurrence of vibration situations.

Further, the background system, in particular the operating parameter change module, can be configured to set operating data of ticketing devices and send the data to the ticketing devices by means of data transmission. In particular, according to the application, the background system is configured to enable or disable the recording of vibration patterns together with measurement data for individual mobile ticketing devices individually by operating data settings.

A still further aspect of the application is a method of monitoring a mobile ticketing device, in particular a previously described mobile ticketing device. The method comprises:
measuring, by at least one acceleration sensor of the mobile ticketing device, an acceleration impacting the mobile ticketing device,
wherein measuring the acceleration comprises providing time-resolved acceleration values,
generating, by at least one generator module of the mobile ticketing device, at least one measurement data set containing at least one acceleration datum about at least one provided acceleration value, and
outputting, by at least one output module of the mobile ticketing device, the at least one generated measurement data set.

A module (e.g., evaluation module, generator module, etc.), an equipment (e.g., evaluation equipment, etc.), an element (e.g., integration computing element, etc.) or a device can be at least partly formed from software and/or at least partly formed from hardware. In particular, a device/module may comprise suitable computing elements (e.g., processor, memory, etc.) to execute software elements (or computer code). It should also be noted that terms such as “first”; “second”, etc. do not indicate an order, but are used in particular to distinguish between two elements.

The features of the mobile ticketing devices, passenger transport systems and methods can be freely combined with each other. In particular, features of the description and/or of the dependent claims may be independently inventive, even by completely or partially bypassing features of the independent claims, in sole position or freely combined with each other.

### BRIEF DESCRIPTION OF THE DRAWINGS

There are now a multitude of possibilities for designing and further developing the mobile ticketing device according to the application, the passenger transport system according to the application and the method according to the application. In this regard, reference is made on the one hand to the claims subordinate to the independent claims, and on the other hand to the description of embodiments in connection with the drawing. The drawings show:

FIG. 1 a schematic view of an embodiment of a mobile ticketing device according to the present application,

FIG. 2 a schematic view of a further embodiment of a mobile ticketing device according to the present application,

FIG. 3 a schematic view of an embodiment of a passenger transport system according to the present application, and

FIG. 4 a diagram of an embodiment of a method according to the present application.

Similar elements are hereinafter designated by similar reference signs.

### DETAILED DESCRIPTION OF SPECIFIC EMBODIMENTS

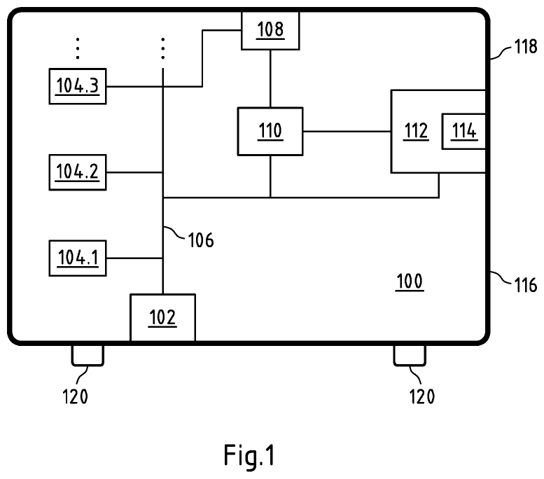

FIG. 1 shows a schematic view of an embodiment of a mobile ticketing device 100 according to the present application. The mobile ticketing device 100 may in particular be a ticket vending machine or a farebox. In an intended operation, the mobile ticketing device 100 may be fixedly respectively permanently installed in a transport vehicle (not shown here) by means of at least one mechanical connector equipment 120 respectively a mechanical fastening means 120. A mobile ticketing device 100 is generally configured at least to issue a ticket medium respectively a ticket.

The shown mobile ticketing device 100 comprises an electrical connector equipment 102. The electrical connector equipment 102 serves to connect respectively electrically couple the mobile ticketing device 100 to an on-board power supply of a transport vehicle (not shown here). Through this, the electrical energy and electrical power, respectively, required for the operation of the at least one electrically operated ticketing module 104.1, 104.2, 104.3 of the mobile ticketing device 100 can be provided to the mobile ticketing device 100. In further variants of the application, at least one mechanically operated ticketing module may be provided alternatively or additionally. A voltage signal provided by the on-board power supply of the transport vehicle can be applied at the electrical connection device 102.

Exemplary ticketing modules 104.1, 104.2, 104.3 comprise a printer 104.1, in particular a thermal printer, a money handling equipment 104.2, for example with an electric motor for drawing in banknotes and a (coin) money storage, a display 104.3 and/or the like. These ticketing modules 104.1, 104.2, 104.3 may be connected to the electrical connector equipment 102 via an internal power network 106. As described, a ticketing module may perform a ticketing action.

Further, a mobile ticketing device 100 in particular comprises a housing 116 having at least one housing wall 118. The housing 116 respectively the at least one housing wall 118 may be formed of a metal, for example. It shall be understood that other materials may also be used.

According to the application, the mobile ticketing device 100 comprises a monitoring arrangement having at least one acceleration sensor 108, a generator module 110, and an output module 112.

As can be seen, the at least one acceleration sensor 108 is integrated in the mobile ticketing device 100, in particular in the housing 116. For example, the acceleration sensor 108 may be attached to an inner side of a housing wall 118, in particular in the head section of the mobile ticketing device 100. The acceleration sensor 108 may also be suppliable with electrical energy via the internal power network 106.

The acceleration sensor 108 is configured to (continuously) measure the acceleration impacting the mobile ticketing device 100. In particular, shocks and/or vibrations experienced by the transport vehicle during operation may be transmitted to the mobile ticketing device 100, for example via the at least one mechanical fastening means 120 (e.g., an undamped screw connection). By measuring the acceleration, the transmitted shocks and/or vibrations can be detected.

The acceleration sensor 108 is configured to provide the (continuously) measured acceleration in the form of time-dependent acceleration values respectively time-resolved acceleration values. In particular, the acceleration sensor 108 can convert a measured voltage signal representing the acceleration into time-resolved acceleration values. In particular, these acceleration values may be provided to the generator module 110.

The generator module 110 is configured to generate at least one measurement data set comprising at least one acceleration datum, for example at least one acceleration value, about the measured acceleration respectively the provided acceleration values. The acceleration datum may be an (actually) measured acceleration value and/or a value derived respectively calculated therefrom and/or an event associated with the measured acceleration, in particular triggered by the measured acceleration. For example, the acceleration event may be an information that a certain acceleration limit value has been exceeded (or fallen below) by the measured acceleration (or a value calculated therefrom).

The output module 112 is configured to output the generated measurement data set. In particular, the output module 112 may comprise a communication unit 114 configured to transmit the at least one measurement data set to a background system and/or a mobile terminal, for example of a service technician. Exemplary and non-exhaustive mobile terminals in this regard comprise smartphones, tablet computers, mobile gaming consoles, laptops, netbooks, data glasses, smart watches, and similar wearables. In variants of the application, an outputting may also comprise a displaying of the at least one voltage data set by a display of the mobile ticketing device, such as a display. Preferably, the communication unit 114 may be configured to send and receive data.

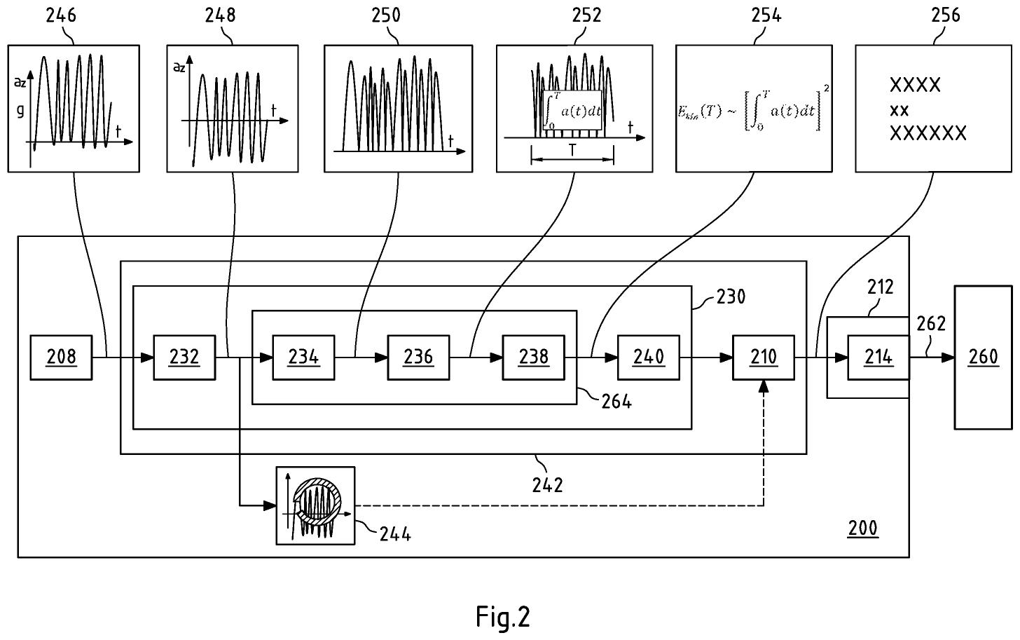

FIG. 2 shows a schematic view of a further embodiment of a mobile ticketing device 200 according to the present application. In order to avoid repetitions, essentially only the differences from the embodiment according to FIG. 1 are described below and otherwise reference is made to the previous explanations. In particular, the illustrated mobile ticketing device 200 may be a farebox.

The illustrated mobile ticketing device 200 comprises at least one acceleration sensor 208. Preferably, the acceleration sensor 208 integrated in the mobile ticketing device 200 may be a 3-axis acceleration sensor 208. In particular, a 3-axis acceleration sensor 208 is configured to measure three voltage signals (one for each axis) that are dependent on the respective acceleration and location of the 3-axis acceleration sensor 208 in the mobile ticketing device. The 3-axis acceleration sensor 208 may be configured to convert or convert the three voltage signals into corresponding axis-related and time-resolved acceleration values. Particularly preferably, a high performance three-axis linear acceleration sensor with very low power consumption may be used. An exemplary acceleration sensor 208 that can be used is the LIS2DW12 sensor from STMicroelectronics.

As can be seen, the acceleration sensor 208 is coupled to an evaluation equipment 230 in the illustrated preferred embodiment. In particular, the mobile ticketing device 200 may comprise a computing module 242. Preferably, the computing module 242 may be an already existing computing module 242, which may for example comprise a (not shown) controller configured to control the at least one ticketing module of the mobile ticketing device 200. In particular, in the form of an executable software module respectively computer program, the computing module 242 may comprise the evaluation equipment 230 and in particular the generator module 210. In variants of the application, the mobile ticketing device 200 may also comprise a computing module configured to evaluate acceleration values only.

The acceleration sensor 208 may provide the digital, time-resolved acceleration values to the evaluation equipment 230. Preferably, the acceleration sensor 208 may have a sampling rate of 100 Hz.

As has already been described, the 3-axis acceleration sensor 208 measures the respective acceleration for all three spatial axes (x-, y- and z-axis) and (continuously) provides respective acceleration values. The evaluation will be described below using the evaluation of the acceleration values of the z-axis as an example. The acceleration values of the other axes can be evaluated in an analogous manner. Following the evaluation, the oscillation energy values determined in each case can be accumulated (for example before a comparison described below). Alternatively or additionally, a 3-axis acceleration sensor 208 can be used, which adds the measured accelerations in all three spatial axes and outputs accumulated values.

The digital, time-resolved acceleration values respectively the corresponding sensor data, as shown by way of example in the diagram 246, can represent the detected vibrations including the impacting gravity g, which impact the mobile ticketing device 200.

Preferably, the evaluation equipment 230 may comprise a high pass filter 232. A high-pass filter 232 is configured to high-pass filter the provided acceleration values. The high-pass filtering removes constant acceleration values, in particular the acceleration due to gravity g, from the time-resolved acceleration values respectively the corresponding sensor data, as shown by way of example in the diagram 248.

As can be seen, the high-pass filtered acceleration values can be provided to a vibration loading module 264 of the evaluation equipment 230, and optionally to a ring memory module 244.

In particular, the vibration loading module 264 is configured to determine an oscillation energy as a measure of the vibration loading of the mobile ticketing device 200 based on the provided, preferably high-pass filtered, acceleration values.

In the shown preferred embodiment, the vibration loading module 264 comprises three elements 234, 236, 238. An absolute value computing element 234 is configured to determine respective acceleration absolute values of the provided high-pass filtered acceleration values. The resulting, time-resolved acceleration values respectively the corresponding sensor data are shown by way of example in the diagram 250.

The determined, in particular calculated, acceleration absolute values can be provided to the integration computing element 236. In particular, the integration computing element 236 is configured to determine a hypothetical velocity Av by calculating a time integral over the determined acceleration absolute values during a specific evaluation time period T. The time integral can be determined, in particular calculated, according to the following formula:

Δv=∫₀^{T}a(t)dt (a)

Here, a(t) is the aforementioned acceleration absolute values and T is the evaluation time period. The evaluation time period T can preferably be 1 to 10 seconds, particularly preferably 2 to 5 seconds. By way of example the corresponding data are shown in the diagram 252.

In particular, the energy computing element 238 is configured to determine the (mean) oscillation energy Eₖᵢₙ(T) by squaring the calculated time integral. For example, as also shown by way of example in the diagram 254, this can be done according to the following formula:

Eₖᵢₙ(T)˜[∫₀^{T}a(t)dt]² (b)

In particular, the mean oscillation energy Eₖᵢₙ(T) represents the vibration load respectively the oscillation load impacting the mobile ticketing device 200 during the evaluation time period T.

Furthermore, the evaluation equipment 230 comprises a comparator module 240. In particular, the comparator module 240 is configured to compare the mean oscillation energy provided by the vibration loading module 264 with a certain oscillation energy limit value, in particular an oscillation energy threshold value. If it is determined in the comparison that the mean oscillation energy is greater than the oscillation energy threshold, then the generator module 210 (also referred to as the recording module) may be informed thereof.

In other words, the generator module 210 is in particular configured to generate the at least one measurement data set only if the determined mean oscillation energy is greater than the determined mean oscillation energy limit value.

The specific, in particular adjustable oscillation energy limit value can in particular be set in such a way that measured accelerations, in particular caused by vibrations, shocks and/or impacts, which are below the oscillation energy limit value have no effect on the operability of the mobile ticketing device. This can achieve that a measurement data set is only generated if there is a (potential) effect of an acceleration on the operability of the mobile ticketing device 200.

In particular, the mean oscillation energy may be compared to the oscillation energy threshold value by the comparator module 240. In particular, only if the mean oscillation energy exceeds the oscillation energy threshold value the occurrence of a problem can be assumed. A measurement data set can now be generated for this by the generator module 210, in particular measurement data can be recorded in the form of process data respectively event data.

The diagram 256 shows by way of example a measurement data set, which in a preferred embodiment may contain the following measurement data:
time stamp (in particular date and time),
ticketing device identifier (in particular farebox ID),
driver identifier (respectively driver ID),
location data (in particular an indication of the location where the vibration situation occurred, for example GPS data, line data, etc.),
fill level data (in particular the fill level of the (coin) money storage of the mobile ticketing device 200),
environmental data (e.g., ambient temperature),
vehicle status data (e.g., such as door status (open or closed), vehicle speed, and/or engine speed).

Optional, the measurement data set may contain a vibration pattern by reading the acceleration values contained in the ring memory (during the generation of the measurement data set) and adding them by the generator module 210 to the measurement data set.

The specific average oscillation energy may be contained as the acceleration datum of the measurement data set. In variants of the application, it may also be provided that the acceleration datum is inherently derived from the generation of the measurement data set. Thus, in this case, the measurement data set is generated only if the certain oscillation energy threshold value is exceeded. The generation and transmission of such a measurement data set may (inherently) represent the acceleration datum.

The output module 212 having the communication unit 214 is configured to output the measurement data set. In particular, the measurement data set may be transmitted via a (wireless and/or wired) communication network 262 to a further system and device, respectively, such as a background system 260 of the passenger transport system and/or a (not shown) mobile terminal (for example of a service technician) of the passenger transport system.

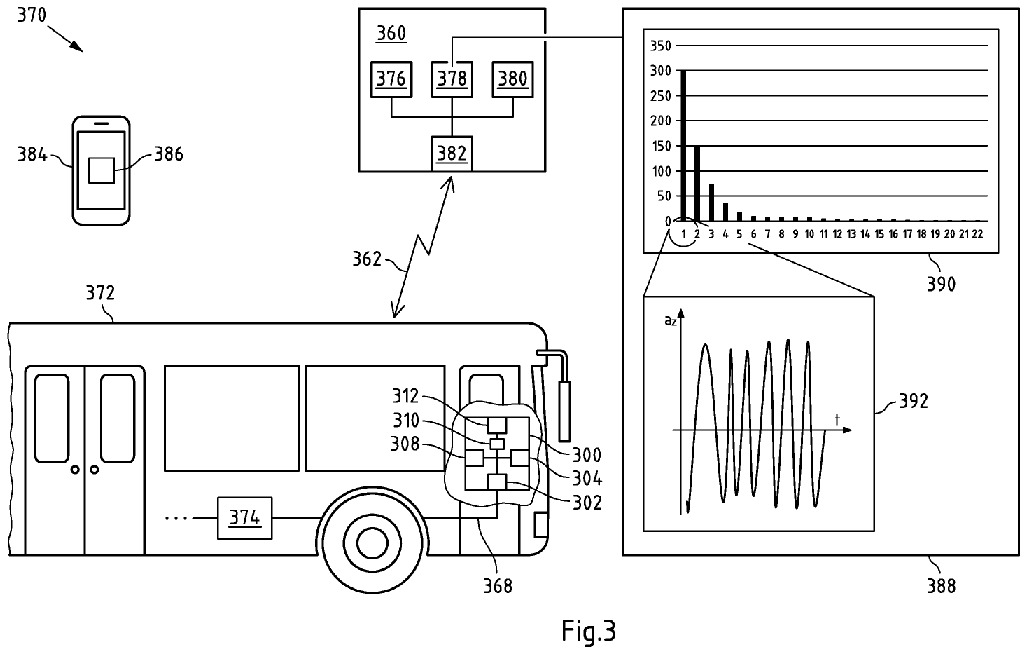

FIG. 3 shows a schematic view of an embodiment of a passenger transport system 370. The passenger transport system 370 comprises at least one mobile ticketing device 300. In particular, for the sake of clarity, only the electrical connector equipment 302, a ticketing module 304, the acceleration sensor 308, the generator module 310 and the output module 312 of the mobile ticketing device 300 are shown. The mobile ticketing device 300 may be formed according to FIG. 1 and/or FIG. 2. In particular, the mobile ticketing device 300 may be a farebox.

Furthermore, the passenger transport system 370 comprises at least one background system 360. The background system 360 may be formed by at least one computing device, for example in the form of a server. For example, a plurality of distributed computing devices may be provided. Also, a cloud system may be implemented as the background system 360.

Preferably, the passenger transport system 370 comprises at least one transport vehicle 372, in particular a plurality of transport vehicles 372. Merely by way of example, the transport vehicle 372 is shown as a bus in which the mobile ticketing device 300 is permanently and fixedly installed.

Optionally, the passenger transport system 370 may comprise at least one mobile terminal 384 (e.g., a smartphone and/or a tablet computer) having a service application 386 installed thereon. In particular, the service application 386 (also referred to as an app) may function similarly to the elements 376, 378, 380 of the background system 360 described below.

The shown mobile ticketing device 300 is connected to the on-board power supply 368 of the transport vehicle 372 by means of the electrical connector equipment 302. The transport vehicle 372 may have at least one vehicle battery 374 configured to provide electrical energy respectively power to the mobile ticketing device 300 and, in particular, to a plurality of other (not shown) electrical loads of the transport vehicle 372.

The background system 360 may comprise at least one communication module 382 configured at least to exchange data with the at least one mobile ticketing device 300. In particular, the output module 312 of the mobile ticketing device 300 may be configured to transmit the at least one set of measurement data to the communication module 382 via a communication network 362, as described hereinbefore. Optionally, further data may be transmitted to the communication module 382 by the output module 312, such as the described sales data sets, etc. In particular, measurement data sets may be transmitted to the background system 360 in an analogous manner from a plurality of mobile ticketing devices of the passenger transport system 370.

In addition to the communication module 382, the background system 360 may comprise a data memory 346, in particular for storing received measurement data sets, an evaluation module 378, and in particular an operating parameter change module 380.

The at least one evaluation module 378 may be configured to evaluate the at least one transmitted measurement data set, in particular the plurality of historical and (previously transmitted) measurement data sets stored in the data memory 376. In particular, the evaluation module 378 may be configured to detect a mobile ticketing device 300 from a plurality of mobile ticketing devices with a vibration load that is outside of a predetermined permissible load range based on the received measurement data sets.

The evaluation module 378 may be configured to determine individuals of the mobile ticketing devices 300 that are determined to have a frequency of generated measurement data sets. This frequency may be determined by comparing the number of all transmitted measurement data sets of all mobile ticketing devices 300 within an evaluation time period. This can be used, for example, to separately consider the particular individuals in a reliability evaluation of the transportation vehicles (fleet of devices) of the passenger transport system and/or to derive targeted service actions on the transportation vehicles and determined mobile ticketing devices 300 where the frequency occurs.

If the mobile ticketing devices 300 are formed according to the embodiment shown in FIG. 2, this evaluation may comprise determining an error distribution across the ticketing device identifiers of preferably all of the mobile ticketing devices 300 of the passenger transport system, as shown by way of example in the upper diagram 390 of diagram 388. For example, the number of measurement data sets received during a given period of time may be determined for each mobile ticketing device 300.

In variants of the application, the evaluation of acceleration values by an evaluation equipment corresponding to FIG. 2 can also be performed in the background system.

In particular, for the mobile ticketing devices 300 whose number of measurement data sets exceeds a certain comparison number of measurement data sets, i.e., which have experienced a vibration load that lies outside a predetermined permissible load range (which may be defined by the certain comparison number), an optional vibration pattern can additionally be evaluated. This is shown by way of example in diagram 392. As has already been described, this can be used in particular to determine the type of vibration (e.g., impact or vibration). Counter measures can then be taken in a targeted manner.

If, in the evaluation, a mobile ticketing device 300 is detected that has experienced a vibration load that is outside a predetermined permissible load range (which may be defined by the determined comparison number), and in particular a vibration pattern for this ticketing device 300 is not available, the operating parameter change module 380 may be configured to generate an operating parameter data set based on said evaluation result of the evaluation module 378, the operating parameter data set containing an operating parameter value indicating that in future measurements the vibration pattern is to be added to a measurement data set. Upon receipt of such an operating parameter data set, the corresponding mobile ticketing device 300 may activate the generating and sending of vibration patterns.

Preferably, transmitted (and stored in the background system 360) historical measurement data sets of a plurality of mobile ticketing devices 300 can be evaluated preferably on a regular basis and/or at specific times.

In particular, the evaluation module 378 may be configured to determine at least one first measurement datum of a first measurement data set that has at least one correlation to at least one further measurement datum of a further measurement data set. Thus, the evaluation module 378 can be configured to identify correlations, for example between vibrations that have occurred and specific types of transport vehicles and/or of vibrations and specific drivers and/or of vibrations and specific routes respectively route sections and/or of vibrations and specific vehicle states or states of a ticketing module.

Preferably, an evaluation in the background system can be focused on detecting statistically significant correlations, such as whether certain drivers generate more measurement data sets (i.e., critical vibration loads) than the average of all drivers, whether frequencies of vibration loads can be detected on certain routes or in certain route sections, whether vibration loads occur more frequently at certain engine speeds of certain vehicles (e.g., determined by manufacturer, type designation, year of manufacture), etc.

As has already been described, the operating parameter change module 380 may be configured to generate an operating parameter data set based on the evaluation result of the evaluation module 378.

The communication module 382 may be configured to transmit the generated operating parameter data set to at least the one detected mobile ticketing device 300 and/or a further vehicle device of the transport vehicle 372 of the corresponding mobile ticketing device 300.

For example, a setting on a ticketing module 304 of the corresponding mobile ticketing device 300 may be changed by the operating parameter data set to at least reduce the risk of temporary failure of the ticketing module 304. For example, the printing speed of a printer 304 may be adjusted and/or the maximum allowable fill level of the (coin) money storage 304 of the mobile ticketing device 300 may be adjusted.

It may also be provided that vehicle parameters, such as the maximum allowed vehicle speed, are adjusted, for example on a certain section of the route. For example, if it is determined in the evaluation that unacceptable vibration situations occur on a specific route section, the maximum permitted vehicle speed may be reduced for that route section.

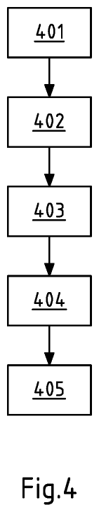

FIG. 4 shows a diagram of a method for monitoring a mobile ticketing device, in particular a mobile ticketing device according to FIGS. 1, 2 and/or 3.

In a step 401, a measuring, by at least one acceleration sensor of the mobile ticketing device, is performed of an acceleration impacting the mobile ticketing device, wherein measuring the acceleration comprises providing time-resolved acceleration values, as already described.

In step 402, a generating, by at least one generator module of the mobile ticketing device, is performed of at least one measurement data set comprising at least one acceleration datum about at least one measured acceleration value, as has been described previously.

In step 403, an outputting, by at least one output module of the mobile ticketing device, is performed of the at least one generated measurement data set, in particular to a background system, as has already been described.

Optionally, in step 404, an evaluation of the output measurement data set can be performed, as previously described.

Further, optionally, in step 405, at least one operating parameter value of the mobile ticketing device and/or the transport vehicle in which the mobile ticketing device is installed may be adjusted, based on the performed evaluation, as has been previously described.

The steps 401 to 405 may be performed at least partially in parallel and in particular repetitively. In particular, after an adjustment of the at least one operating parameter, it can be evaluated whether an improvement of the vibration situation can (or cannot) be achieved thereby. Depending on the result of the evaluation, a further adjustment of the at least one operating parameter can be carried out.

### LIST OF REFERENCE SIGNS

100 ticketing device
102 electrical connector equipment
104 ticketing module
106 internal power network
108 acceleration sensor
110 generator module
112 output module
114 communication unit
116 housing
118 housing wall
120 mechanical fastening means
200 ticketing device
208 acceleration sensor
210 generator module
212 output module
214 communication unit
230 evaluation equipment
232 high-pass filter
234 absolute value computing element
236 integration computing element
238 energy computing element
240 comparator module
242 computing module
244 ring memory module
260 background system
262 communication network
264 vibration loading module
300 ticketing device
302 electrical connector equipment
304 ticketing module
308 acceleration sensor
310 generator module
312 output module
346 data memory
360 background system
362 communication network
368 on-board power supply
370 passenger transport system
372 transport vehicle
374 vehicle battery
376 data memory
378 evaluation module
380 operating parameter change module
382 communication module
384 mobile terminal
386 service application

What is claimed is:

1. A mobile ticketing device for a transport vehicle of a passenger transport system, comprising:
at least one ticketing module configured to perform a ticketing action;
at least one acceleration sensor configured to measure an acceleration impacting the mobile ticketing device, wherein measuring the acceleration comprises providing time-resolved acceleration values;
at least one generator module configured to generate at least one measurement data set, containing at least one acceleration datum about at least one provided acceleration value; and
at least one output module configured to output the at least one generated measurement data set.

2. The mobile ticketing device according to claim 1, wherein the mobile ticketing device further comprises:
at least one evaluation equipment configured to evaluate the provided acceleration values,
wherein the evaluation equipment comprises at least one high-pass filter configured to high-pass filter the provided acceleration values.

3. The mobile ticketing device according to claim 1, wherein the mobile ticketing device further comprises:
at least one evaluation equipment configured to evaluate the provided acceleration values,
wherein the evaluation equipment comprises at least one vibration loading module configured to determine an oscillation energy as a measure of the vibration load based on the provided acceleration values,
wherein the acceleration datum is the determined oscillation energy.

4. The mobile ticketing device according to claim 3, wherein the vibration loading module comprises:
an absolute value computing element configured to determine respective acceleration absolute values for the respective provided acceleration values,
an integration computing element configured to determine a hypothetical velocity by calculating a time integral over the determined acceleration absolute values during a certain evaluation time period, and
an energy computing element configured to determine the oscillation energy by squaring the calculated time integral.

5. The mobile ticketing device according to claim 1, wherein the mobile ticketing device further comprises:
at least one evaluation equipment configured to evaluate the provided acceleration values,
wherein the evaluation equipment comprises at least one comparator module configured to compare the provided acceleration values with a specific acceleration limit value,
wherein the generator module is configured to generate the at least one measurement data set only if at least one absolute value of the provided acceleration values is greater than the specific acceleration limit value.

6. The mobile ticketing device according to claim 5, wherein
the comparator module is configured to suspend the comparison for a certain dead time if at least one absolute value of the provided acceleration values is greater than the determined acceleration limit value.

7. The mobile ticketing device according to claim 1, wherein the at least one generated measurement data set contains at least one measurement datum selected from the group comprising:
ticketing device identifier,
timestamp,
driver identifier,
fill level of the money storage of the mobile ticketing device,
route number and/or line number,
location data of the transport vehicle,
at least one environment datum of the mobile ticketing device,
at least one vehicle datum of the transport vehicle.

8. The mobile ticketing device according to claim 1, wherein the mobile ticketing device further comprises:
at least one ring memory module configured to store the provided acceleration values with a certain holding time.

9. The mobile ticketing device according to claim 8, wherein the mobile ticketing device further comprises:
at least one evaluation equipment configured to evaluate the provided acceleration values,
wherein the evaluation equipment comprises at least one vibration loading module configured to determine an oscillation energy as a measure for the vibration load based on the acceleration values stored in the ring memory module,
wherein the acceleration datum is the determined oscillation energy.

10. The mobile ticketing device according to claim 8, wherein
the generator module is configured to generate the at least one measurement data set additionally containing the acceleration values stored in the ring memory module as a vibration pattern.

11. A passenger transport system comprising:
at least one mobile ticketing device installed in a transport vehicle according to claim 1; and
at least one background system comprising at least one communication module,
wherein the output module of the mobile ticketing device is configured to transmit the at least one measurement data set to the communication module.

12. The passenger transport system according to claim 11, wherein the background system further comprises:
at least one evaluation module configured to detect a mobile ticketing device from a plurality of mobile ticketing devices with a vibration load that is outside of a predetermined permissible load range based on the received measurement data sets.

13. The passenger transport system according to claim 12, wherein
the evaluation module is configured to evaluate a plurality of transmitted measurement data sets,
wherein the evaluating of the plurality of transmitted measurement data sets comprises determining at least one first measurement datum of a first measurement data set that has at least one correlation to at least one further measurement datum of a further measurement data set.

14. The passenger transport system according to claim 12, wherein
the evaluation module is configured to determine individuals of the mobile ticket devices at which a frequency of generated measurement data sets is detected.

15. The passenger transport system of claim 12, wherein
the background system comprises at least one operating parameter change module configured to generate an operating parameter data set based on the evaluation result of the evaluation module, and
the communication module is configured to transmit the generated operating parameter data set to at least the one detected mobile ticketing device and/or a further vehicle device of the corresponding mobile ticketing device.

16. A method for monitoring a mobile ticketing device, comprising:
measuring, by at least one acceleration sensor of the mobile ticketing device, an acceleration impacting the mobile ticketing device, wherein measuring the acceleration comprises providing time-resolved acceleration values;
generating, by at least one generator module of the mobile ticketing device, at least one measurement data set containing at least one acceleration datum about at least one provided acceleration value; and
outputting, by at least one output module of the mobile ticketing device, the at least one generated measurement data set.

17. The mobile ticketing device according to claim 9, wherein the vibration loading module is configured to determine the oscillation energy as a measure for the vibration load based on the acceleration values stored in the ring memory module and the acceleration values provided for an adjustable stopping time.
